(19) United States
(12) Patent Application Publication
(10) Pub. No.: US 2025/0228650 A1
(43) Pub. Date: Jul. 17, 2025

(54) DEVICE AND METHOD FOR CREATING DENTAL PROSTHESIS

(71) Applicants: Andre Samoel, Orchard Park, NY (US); Andrea Samoel, Orchard Park, NY (US); David Fowler, Clemmons, NC (US)

(72) Inventors: Andre Samoel, Orchard Park, NY (US); Andrea Samoel, Orchard Park, NY (US); David Fowler, Clemmons, NC (US)

(21) Appl. No.: 19/019,152

(22) Filed: Jan. 13, 2025

Related U.S. Application Data
(60) Provisional application No. 63/619,912, filed on Jan. 11, 2024.

(51) Int. Cl. A61C 13/00; A61C 9/00

(52) U.S. Cl. CPC A61C 13/0006; A61C 9/0006; A61C 13/0004

(57) ABSTRACT

A bite registration device and method for creating a dental prosthesis, the bite registration device comprising a fixed housing having a bottom surface and a top surface that defines a cavity that houses a yoke assembly and a rotational control assembly. A base plate connected to the bottom surface of the fixed housing, and a lower impression tray to hold a first amount of removable impression putty, attached to the bottom surface of the fixed housing, wherein the rotational control assembly controls the movement of the lower impression tray. An upper impression tray to hold a second amount of removable impression putty, attached to the top surface of the fixed housing, wherein the yoke assembly controls the movement of the lower impression tray. A bite registration device controller for regulating alignment of the upper impression tray and the lower impression tray.

### CROSS REFERENCE TO RELATED APPLICATION

The present invention relates to a dental instrument, and particularly to a device and method for creating dental prosthesis. This application claims the benefit of U.S. Provisional application Ser. No. 63/619,912, filed Jan. 11, 2024, having the title for DEVICE FOR CREATING DENTAL PROSTHESIS, which is incorporated herein by reference in its entirety.

### FIELD OF THE INVENTION

The present invention relates to a dental instrument, and particularly to a device and method for creating dental prosthesis.

### BACKGROUND

Background description includes information that may be useful in understanding the present invention. It is not an admission that any of the information provided herein is prior art or relevant to the presently claimed invention, or that any publication specifically or implicitly referenced is prior art. To replace missing teeth, dentists can surgically place fixtures or implants, into the bone of a patient, attaching prosthetic teeth with supporting abutments to replace either single or multiple missing teeth. Crowns may be either screw or cement retained onto these supporting abutments. In recent years, there has been a trend away from external, to internally configured implants. Internally configured designs appear to be more stable, have less risk of screw breakage, and are capable of withstanding more force load. External hex implants are more prone to problems with screw loosening or breakage.

After surgery, patients are typically given a number of months to heal, though in some instances, implants are immediately loaded with provisional crowns. The healing period will permit the implant to biologically and mechanically integrate with the maxillary or mandibular bone. This bio-integration is critical to the long-term success of the restoration. Successful integration ensures resistance to the repeated mechanical forces of mastication and sometimes parafunction (clenching or bruxing).

At the end of the healing period, usually 4-6 months, healing is considered complete. At this time, the healing screw is removed, a transfer coping screwed into the implant, and a dental impression is made to capture the precise position and relationship of the implant to the soft tissues, adjacent structures and the rest of the arch form. An additional impression is made of the opposing arch. It is important that these impressions be highly accurate and detailed, so that the resulting models accurately reflect the intraoral relationships. It is also critical that an accurate bite registration be fabricated, relating both arches for mounting on an articulator, a device that will help reproduce contact patterns and a range of jaw movements. This will help minimize adjustments in the mouth and help create a final result that will be both functional and esthetic, one that is biocompatible, not inflicting any harm to the implants, muscles, or tempero-mandibular joint.

In a properly equilibrated dentition, when restoring a single tooth or teeth surrounded by healthy natural teeth, casts might simply be articulated to a habitual position. However, when replacing a quadrant or full arch of teeth, making a bite registration becomes an essential part of the process. Without an existing component to accomplish this, often the laboratory will have to fabricate a screw retained device that can be used to make the registration. This is accomplished at a separate patient appointment, adding both cost and time.

Thus, there is a need of a device for creating dental prosthesis, which overcomes the above-mentioned shortcomings of conventional devices.

### SUMMARY OF THE INVENTION

The present invention relates to a system for creating dental prosthesis. The objective of the invention is to overcome the limitations of conventional techniques by efficiently registering a patient bite for the purpose of creating a fully digital dental prosthesis.

According to an aspect of the present disclosure, a bite registration device for creating dental prosthesis is disclosed. The bite registration device that digitally registers a patient bite for the purpose of creating a fully digital dental prosthesis. It is a fully autoclavable instrument that records the relationship of the maxilla to the hinge axis of rotation of the mandible. To do this, the device digitally records the spatial relationship of the maxillary and mandibular dental arch to the patient's anatomic horizontal natural head reference point (resting position), scientifically agreed upon as being the Frankfort plane, and then digitally transfers the relationship to a digital articulator.

These efforts will improve quality of care to existing patient/dentist relationships while simultaneously allotting the ability to offer dental care to all demographics of people worldwide, without restraints placed on material needs and/or availability. Dentists will see a rise in profits due to increased efficiencies in the process by eliminating multiple office visits and unnecessary material waste. Patients will have less discomfort and time spent in dentist offices duplicating the same dental techniques multiple times. Moreover, the device offers a greener, more sustainable solution comprised of medical grade stainless steel which is autoclavable.

The device improves efficiency with a higher degree of accuracy. Additionally, the device eliminates the need for multiply dental visits. Reduce Dentist chair time, increase Dentist revenues, minimize waste required to configure the measurements and data for each patient, and enable higher quality dental care across the globe.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

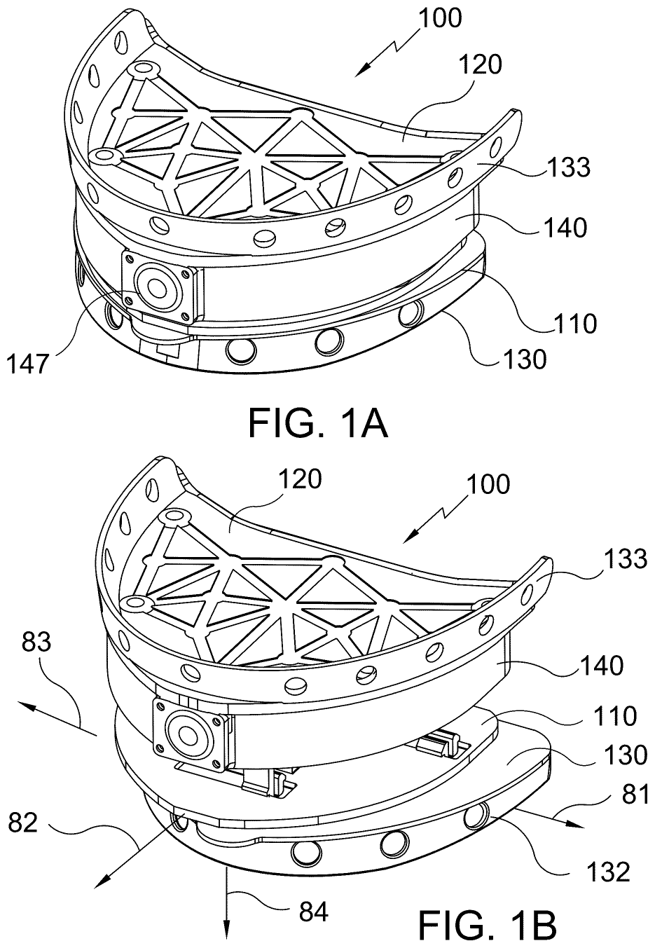

FIG. 1A illustrates a perspective view of components of the bite registration device, in accordance with an embodiment of the present invention;

FIG. 1B illustrates an perspective view of components of the bite registration device, in accordance with an embodiment of the present invention;

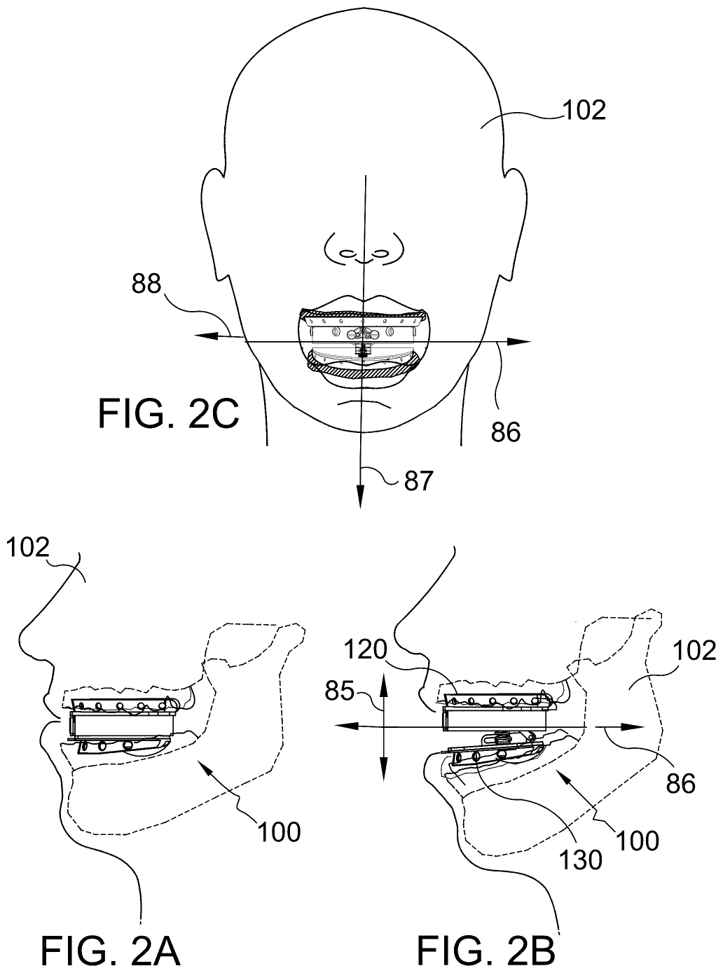

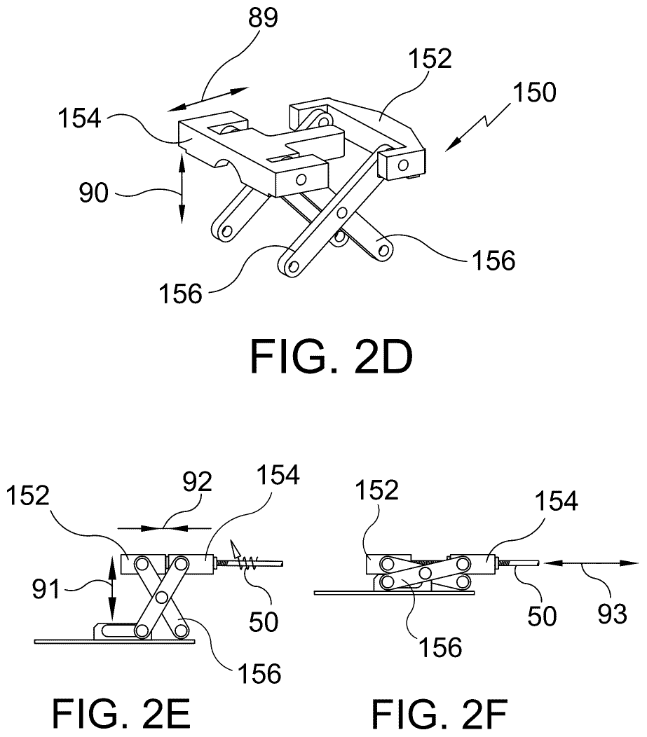

FIG. 2A illustrates a side view of a closed bite registration device for making a dental impression in the mouth of a user, in accordance with an embodiment of the present invention;

FIG. 2B illustrates a side view of an open bite registration device for making a dental impression in the mouth of a user, in accordance with an embodiment of the present invention;

FIG. 2C illustrates a front view of an open bite registration device for registering dental impression in the mouth of a user, in accordance with an embodiment of the present invention;

FIG. 2D illustrates a perspective view of the yoke assembly of the bite registration device, in accordance with an embodiment of the present invention;

FIG. 2E illustrates a side view of the yoke assembly of the bite registration device, in accordance with an embodiment of the present invention;

FIG. 2F illustrates a side view of the yoke assembly of the bite registration device, in accordance with an embodiment of the present invention;

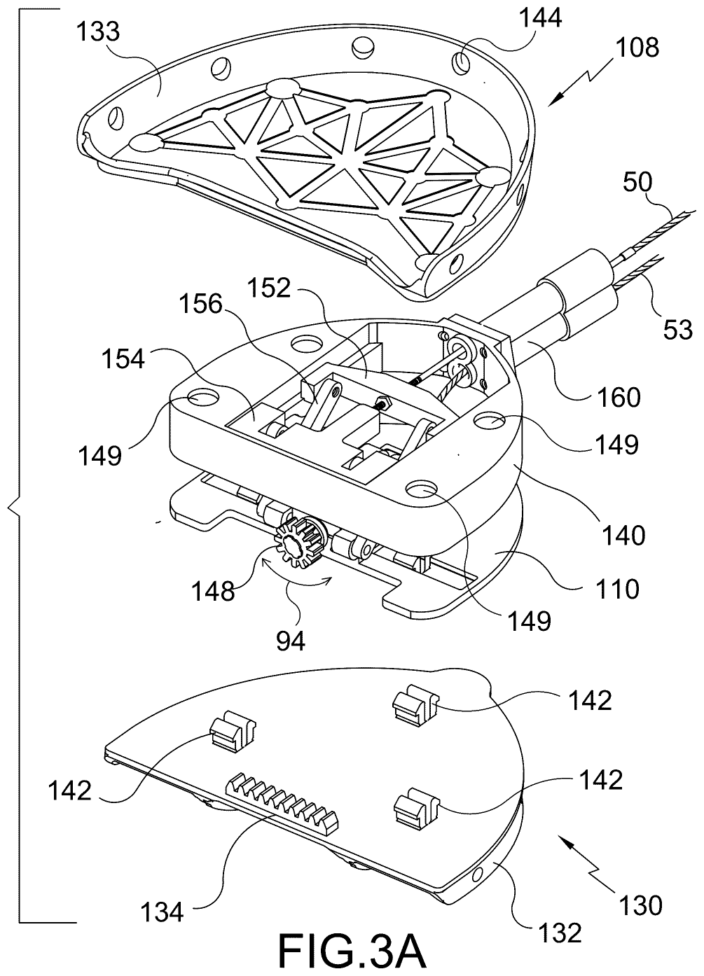

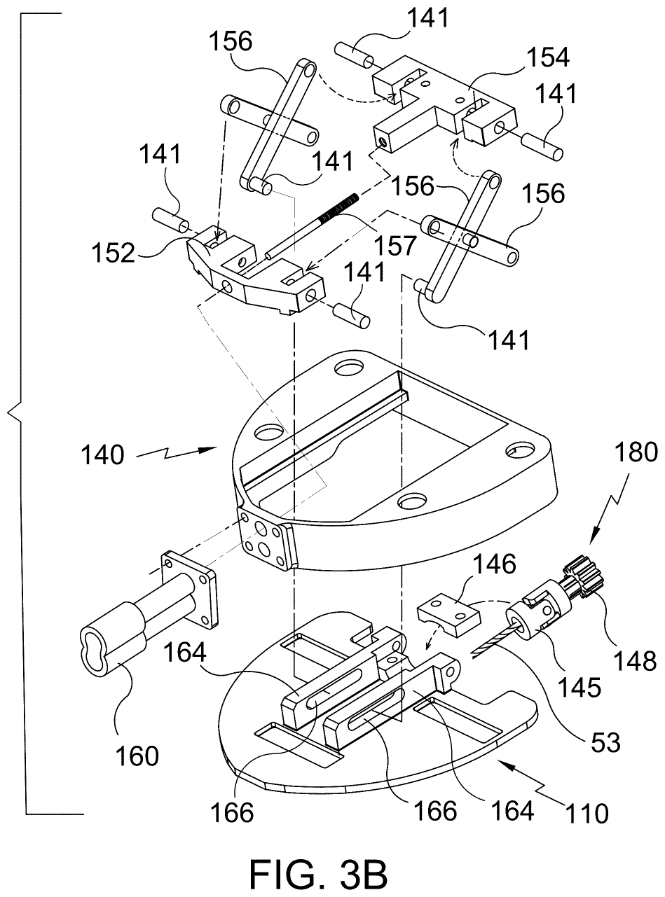

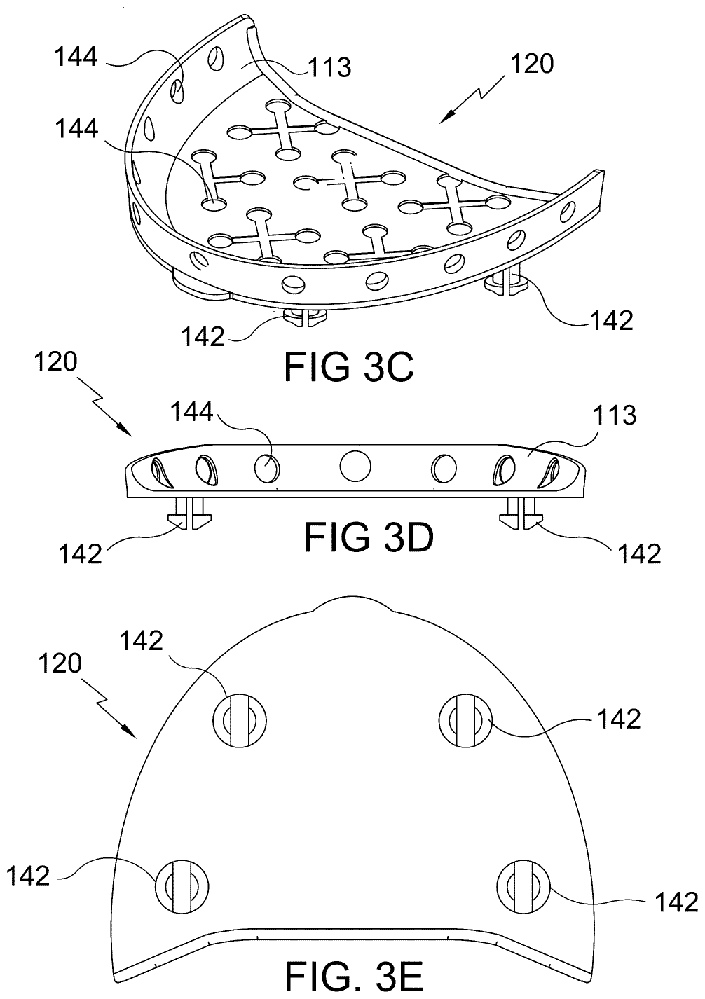

FIG. 3A illustrates an exploded view of components of the bite registration device, in accordance with an embodiment of the present invention;

FIG. 3B illustrates an exploded view of components of the bite registration device, in accordance with an embodiment of the present invention;

FIG. 3C illustrates a perspective view of a lower tray of the bite registration device, in accordance with an embodiment of the present invention;

FIG. 3D illustrates a front view of a lower tray of the bite registration device, in accordance with an embodiment of the present invention;

FIG. 3E illustrates a bottom view of the T-slot tabs of the lower tray of the bite registration device, in accordance with an embodiment of the present invention;

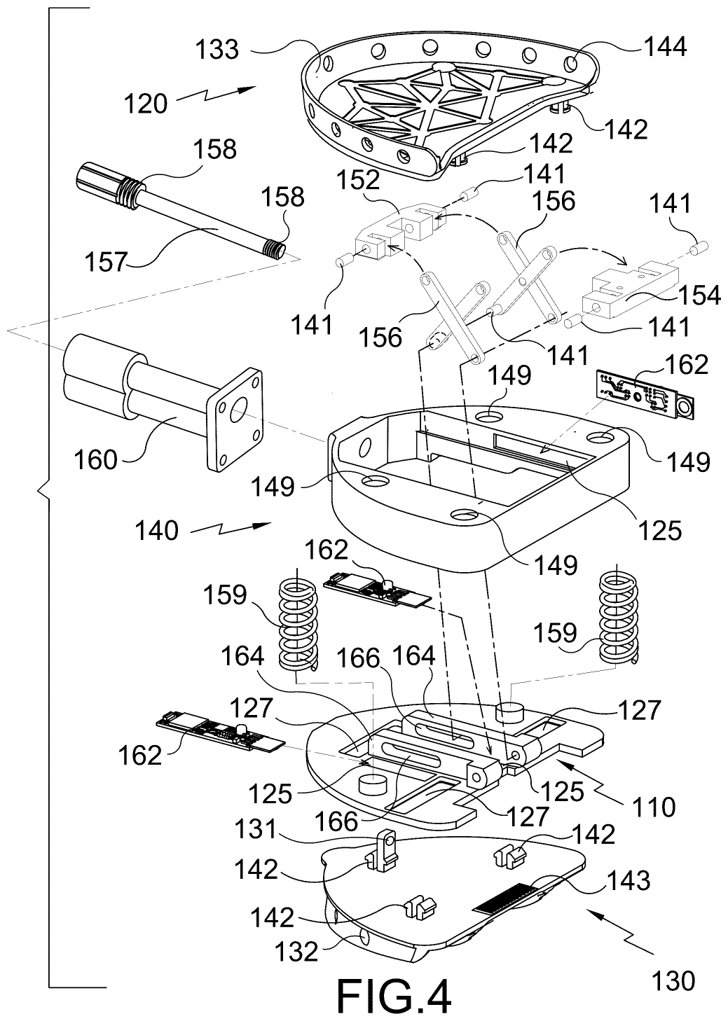

FIG. 4 illustrates an exploded view of components of the bite registration device, in accordance with an embodiment of the present invention;

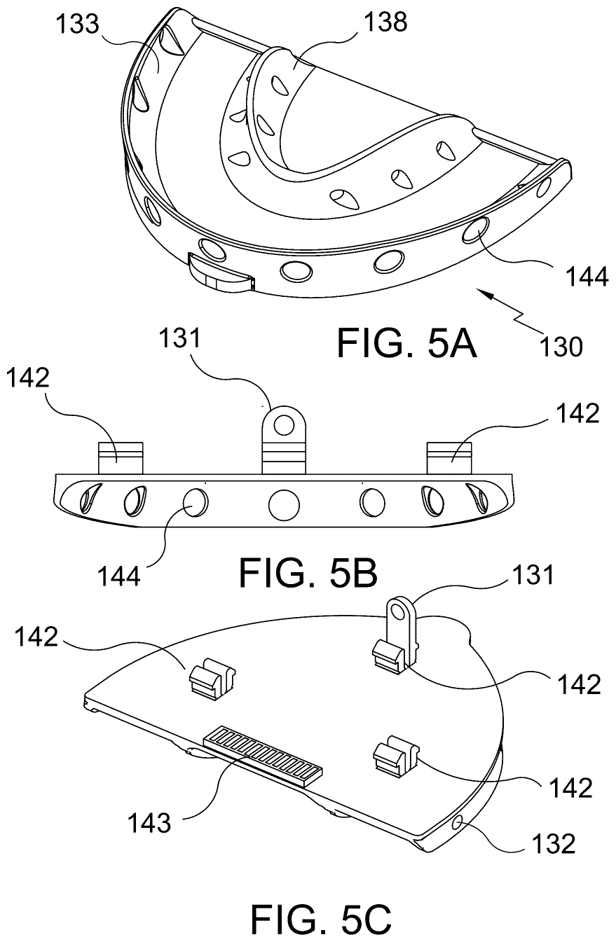

FIG. 5A illustrates a perspective view of a mandibular lower tray of the bite registration device, in accordance with an embodiment of the present invention;

FIG. 5B illustrates a front view of a mandibular lower tray of the bite registration device, in accordance with an embodiment of the present invention;

FIG. 5C illustrates a bottom view of the mandibular lower tray of the bite registration device, in accordance with an embodiment of the present invention;

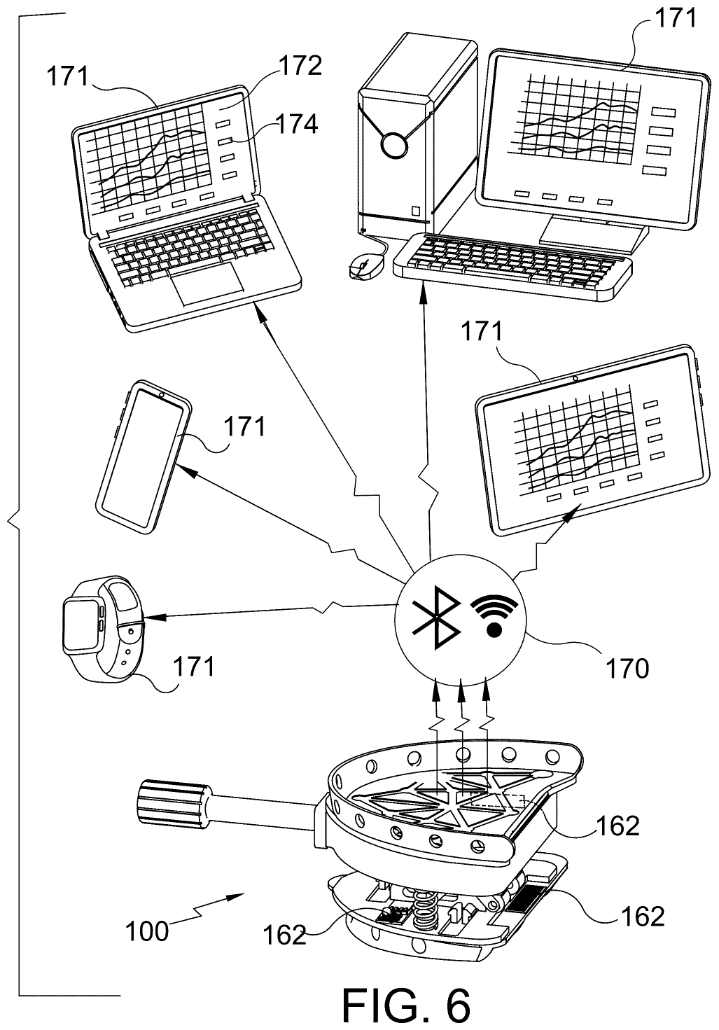

FIG. 6 illustrates a schematic diagram of the Wi-Fi and Bluetooth connectivity of the device, in accordance with an embodiment of the present invention;

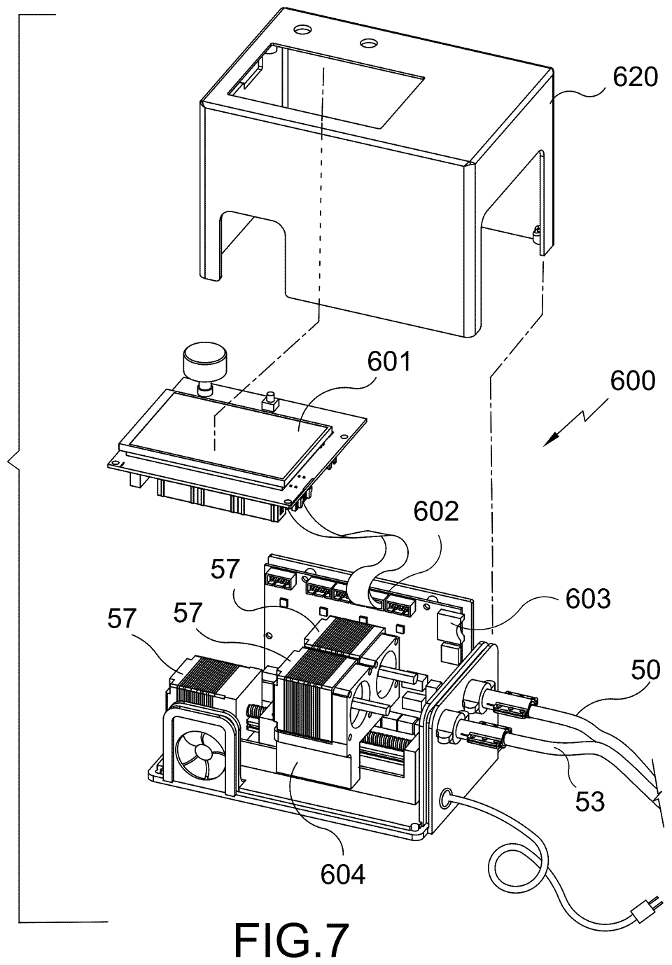

FIG. 7 illustrates a perspective view the device controller, in accordance with an embodiment of the present invention;

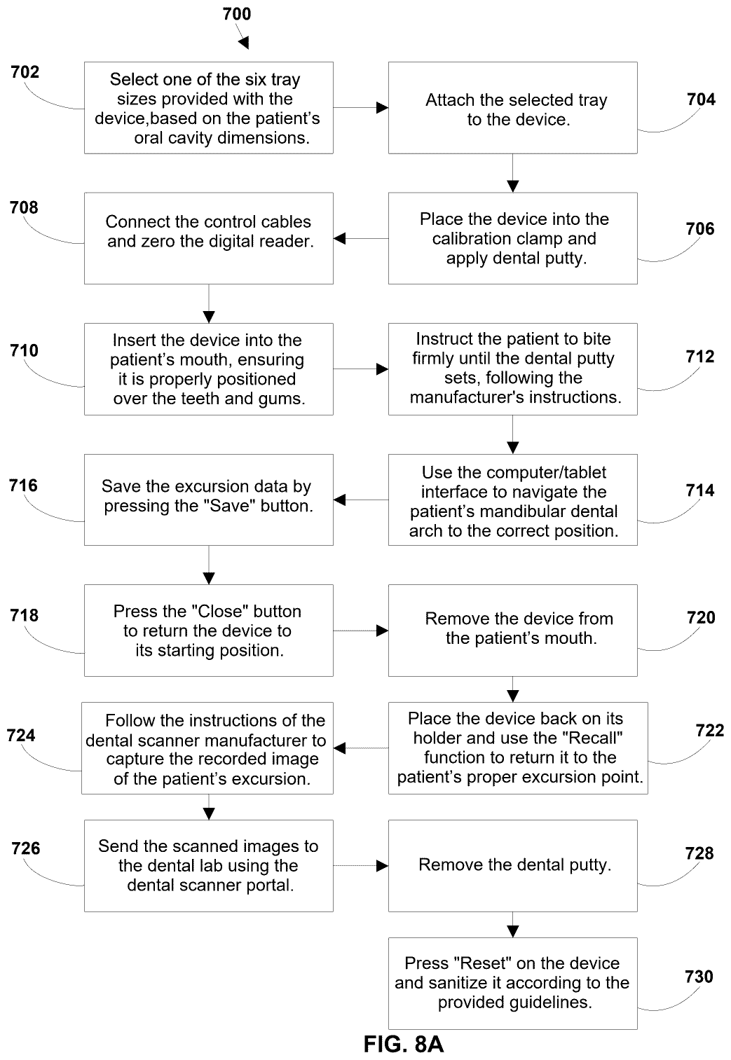

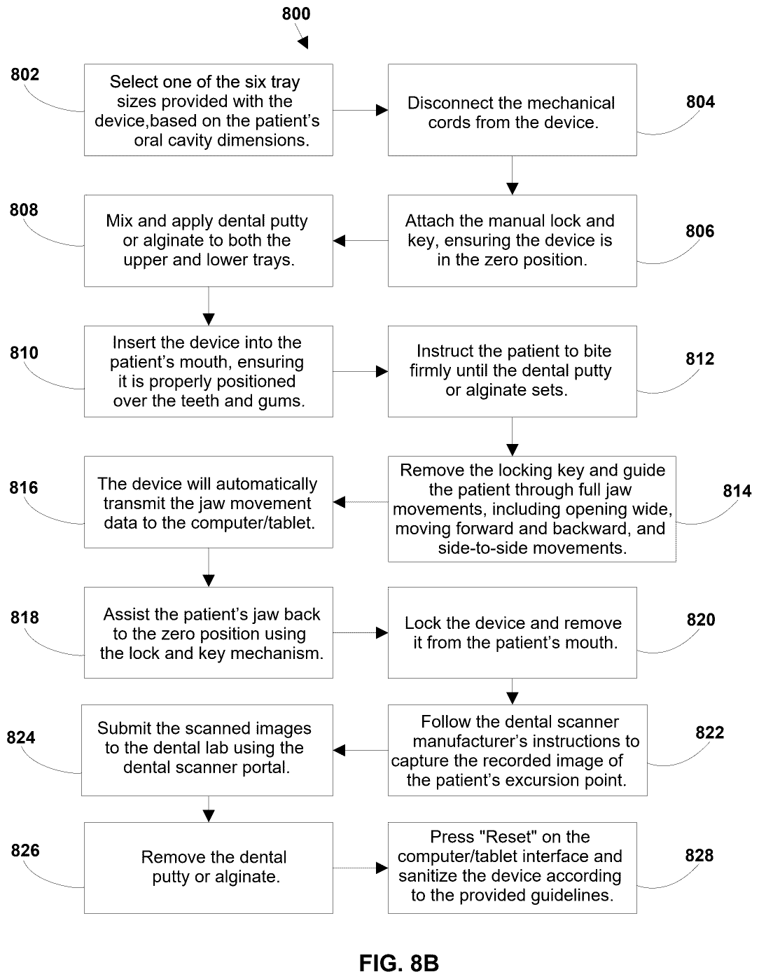

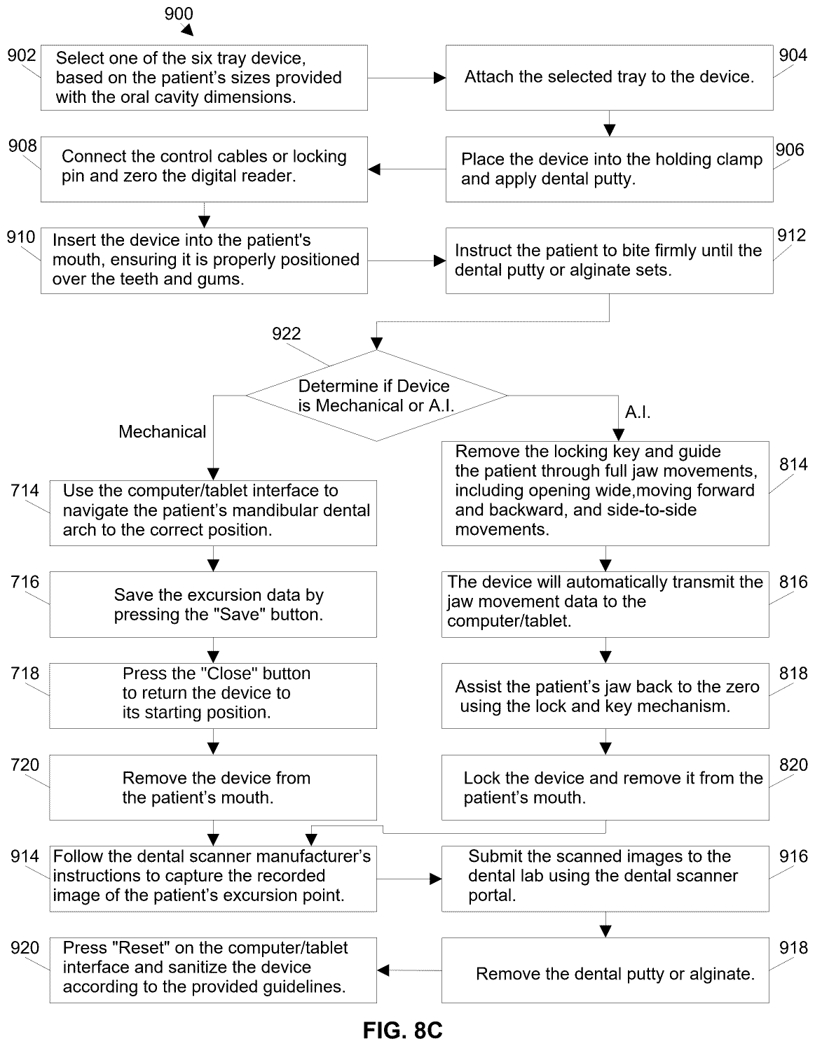

FIG. 8A illustrates an example of a flowchart of the mechanically-operated bite registration method for the device, in accordance with an embodiment of the present invention;

FIG. 8B illustrates an example of a flowchart of the artificial intelligence-operated bite registration method of the device, in accordance with an embodiment of the present invention; and

FIG. 8C illustrates an example of a flowchart of the device operation method 900 for both the mechanically-operated and artificial intelligence-operated bite registration embodiments, in accordance with an embodiment of the present invention.

### DETAILED DESCRIPTION OF THE EMBODIMENTS

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The term “some” as used herein is to be understood as “none or one or more than one or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments, without departing from the scope of the present disclosure.

The terminology and structure employed herein is for describing, teaching, and illuminating some embodiments and their specific features. It does not in any way limit, restrict or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not be necessarily taken as limiting factors to the attached claims. The attached claims and their legal equivalents can be realized in the context of embodiments other than the ones used as illustrative examples in the description below. Embodiments of the present disclosure will be described below in detail with reference to the accompanying drawings.

Reference is now made in detail to the description of the embodiments as illustrated in the drawings. While several embodiments are described in the connection with these drawings, there is no intent to limit the disclosure to the embodiment or embodiments disclosed herein. On the contrary, the intent is to cover all alternatives, modifications, and equivalents.

It should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

The present invention relates to a bite registration device and method to digitally register a bite of a person for the purpose of creating a fully digital dental prosthesis. The bite registration device and method for creating a dental prosthesis, generally comprises a fixed housing having a bottom surface and a top surface that defines a cavity that houses a yoke assembly and a rotational control assembly. A base plate connected to the bottom surface of the fixed housing, and a lower impression tray to hold a first amount of removable impression putty, attached to the bottom surface of the fixed housing, wherein the rotational control assembly controls the movement of the lower impression tray. An upper impression tray to hold a second amount of removable impression putty, attached to the top surface of the fixed housing, wherein the yoke assembly controls the movement of the lower impression tray. A bite registration device controller for regulating alignment of the upper impression tray and the lower impression tray.

The bite registration device is a fully autoclavable instrument that records the relationship of the maxilla to the hinge axis of rotation of the mandible. For such operation, the device digitally records the spatial relationship of the maxillary and mandibular dental arches to the anatomic horizontal natural head reference point. The bite registration device and method incorporates multiple custom-sized trays, tailored for varying dental arch dimensions, to optimize the process of capturing precise dental impressions and jaw alignment data. Each bite registration device includes an upper and lower tray, fabricated with strategically placed grooves and cavities, overflow channels, and perforated holes. These design elements ensure the secure retention of impression material, such as dental putty or alginate, during the impression-taking process.

To properly fit a patient, the dentist selects the appropriate size trays for the patient's upper and lower dental arches. Dental impression putty or alginate is placed in both trays, and the patient bites down into the material. As the patient closes their bite, excess impression material flows through the cavities/grooves and into the overflow channels and perforated holes. These features prevent material displacement and lock the impression material securely within the tray, ensuring stability and accuracy.

Simultaneously, the grooves and perforations embed markers within the impression material. These markers serve as reference points for an intraoral scanner, enabling precise digital capture of the dental blueprint. Additionally, the secure retention of the impression material in the trays provides structural support, ensuring that the bite registration device remains firmly in place within the jaw alignment process.

The mechanical bite registration device and method not only simplifies the process of capturing dental impressions but also enhances the accuracy and reliability of intraoral scans and jaw alignment data, making it a crucial advancement in dental prosthetic manufacturing.

Adverting now to the drawings, with reference to FIG. 1A, a preferred embodiment of the present disclosure is depicted as bite a bite registration device 100.

FIG. 1A is a perspective view of a bite registration device for registering dental impression in the closed mouth of a user, in accordance with an embodiment of the present invention. The bite registration device 100 comprises a fixed housing 140, a drive port 147, a base plate 110, a maxillary upper tray 120 for taking an upper impression, and a mandibular lower tray 130 for taking a lower impression. The bite registration device 100 allows for controlled alignment of the maxillary upper tray 120 and mandibular lower tray 130 which are putty trays that hold putty, are configured to adjust for the proper fit while enabling the location of the impressions to be recreated during 3D scanning for replica production. The fully assembled bite registration device 100 is shown in a position ready to capture data.

FIG. 1B illustrates an perspective view of components of the bite registration device, in accordance with an embodiment of the present invention. The fully assembled bite registration device 100 is shown ready to capture data. The device includes the maxillary upper tray 120, fixed housing 140, base plate 110, and mandibular lower tray 130. The bite registration device 100 facilitates various mandibular movements, including lateral movement to the right as indicated by arrow 81, mandibular advancement forward as indicated by arrow 82, right as indicated by arrow 83, opening/downward movement as indicated by arrow 84, and lateral movement to the left as indicated by arrow 88.

Each component of the base plate 110 may be made of but not limited to surgical-grade stainless steel, such as 316L, 440, 420 stainless steel, silver, gold, platinum palladium, copper, wood, abs, plastic, polypropylene, polyvinyl, polyethylene terephthalate, polystyrene, acrylonitrile butadiene styrene, polycarbonate, polymethyl methacrylate, HDPE, low-density polyethylene, high-density polyethylene, thermoplastic, polyoxymethylene, polyurethane, thermosetting polymer, polyester, nylon, ultra-high-molecular-weight polyethylene, engineering plastic, polyether keton, polyetherimide, polyolefin, polysulfone, polyimide carbon fiber, acrylic, fiber glass, ceramic, brass, lead, bronze, tungsten, tin, cobalt, carbon steel, alloy, cast iron, steel, alloy steel, aluminum, mercury, nickel, zinc, iron, chromium, magnesium, titanium, acrylonitrile butadiene styrene, polylactic acid, high impact polystyrene, PETG, nylon, High Impact Polystyrene (HIPS), ninjaflex, polyvinyl alcohol, abs filament, carbon PLA, nylon filament, HIPS filament), and the like for sanitary reasons and ability to be exposed to high heat for cleaning.

FIG. 2A illustrates a side view of a closed bite registration device for making a dental impression in the mouth of a patient 102, in accordance with an embodiment of the present. The fully assembled bite registration device 100 is shown ready to capture data in the zero position or closed mouth position. For such operation, the device digitally records the spatial relationship of the maxillary and mandibular dental arches to the patient's anatomic horizontal natural head reference point. In one implementation, the head reference point may be the resting position. Furthermore, this relationship can be digitally transferred to a digital articulator. The digital articulator utilizes this relationship to create a dental prosthesis.

FIG. 2B illustrates a side view of an open bite registration device for making a dental impression in the mouth of a patient 102, in accordance with an embodiment of the present invention. The complete bite registration device 100 enables mandibular movements with the mandibular lower tray 130, including downward, forward, occlusion/upward movement as indicated by arrow 85, and retraction/backward movement as indicated by arrow 86.

FIG. 2C illustrates a front view of an open bite registration device for registering dental impression in the mouth of a user, in accordance with an embodiment of the present invention. The bite registration device 100 facilitates mandibular movements, including lateral movement to the right as indicated by arrow 86, opening/downward movement as indicated by arrow 87, and lateral movement to the left as indicated by arrow 88.

FIG. 2D illustrates a perspective view of a yoke assembly 150 of the bite registration device 100 in a neutral position, in accordance with an embodiment of the present invention. The yoke assembly 150 is comprised of the front yoke 152 and back yoke 154, and scissor jack arms 156. While FIGS. 2E and 2F illustrate the yoke assembly 150 in fully closed and open positions, it is important to note that the device can be adjusted to any intermediate position between open and closed to accurately capture a patient's bite impression. FIG. 2D uses arrow 89 to show the direction of movement when bringing the yokes together, while arrow 90 indicates that the yoke assembly moves up as the front yoke 152 and back yoke 154 are brought together and down when the yokes move apart.

FIG. 2E illustrates a side view of the yoke assembly of the bite registration device 100 in the closed position, in accordance with an embodiment of the present invention. As shown in FIG. 2E, the scissor jack arms 156 allow for movement from a closed to an open position; in this instance, the front yoke 152 and back yoke 154 are in the closed position. FIG. 2E uses arrow 92 to show the direction of movement when bringing the yokes together, while arrow 91 indicates that the yoke assembly moves up as the front yoke 152 and back yoke 154 are brought together and down when the front and back yokes move apart.

FIG. 2F illustrates a side view of the yoke assembly 150 of the bite registration device 100 in the open position, in accordance with an embodiment of the present invention. The yoke assembly is operated by the first cable 50 to enable forward, backward, upward, and downward movements of the mandibular lower tray 130. The yoke assembly is controlled through the first cable 50 when pushed or pulled as shown by arrow 93, controls the movement of the yoke assembly 150.

FIG. 3A illustrates an exploded view of the device's components, in accordance with an embodiment of the present invention. The maxillary upper tray 120, which holds impression putty or alginate, is attached to the fixed housing 140 using a snap connection pin 142 (shown if FIG. 3C-E). The fixed housing 140 includes a first cable 50 for controlling forward, backward, upward, and downward movements of the mandibular lower tray 130 and a second cable 53 for controlling left and right movements of the mandibular lower tray 130, which run through a connection adaptor 160. Both the yoke assembly and the spur gear are cable-driven adjustments for forward, backward, and rotational motions.

The second cable 53 runs through a connection adaptor 160 into the fixed housing 140 and connects to the rotating spur gear 148, which controls the left and right movements of the mandibular lower tray 130. The second cable 53 is responsible for controlling and rotating the spur gear 148. The spur gear 148 is designed to rotate in any direction, as indicated by arrow 94, and engages with a rack gear 134 on the base plate 110. When the spur gear 148 rotates, it uses the rack gear to move the mandibular lower tray 130 left or right. The mandibular lower tray 130 is attached to the fixed housing 140 using a series of square snap pin 142.

The mandibular lower tray 130 includes a lower tray putty cup wall 132, which contains the impression putty or alginate within the mandibular lower tray 130 during operation. This design ensures that the putty or alginate remains securely in place, providing an accurate and stable impression of the patient's bite.

Both the yoke assembly and the rotating spur gear are controlled through the first cable 50 and the second cable 53, which, when pushed or pulled, drive the movement of the device. First cable 50 and the second cable 53 are drive cables, designed similarly to tachometer square cables, are engineered to prevent compression during rotation, pushing, or pulling. These cables are constructed with a flexible core surrounded by a helical wire wrap, providing both strength and flexibility. The outer sheath is made of a durable material to protect against wear and tear. Recommended connection types include snap or splined magnetic connections, which ensure a secure and reliable attachment. Treated surfaces, such as those with anti-corrosion coatings, are acceptable to enhance durability and performance. Additionally, the cables are designed to minimize friction and wear, ensuring smooth and efficient operation over extended periods.

FIG. 3B illustrates an exploded view of the mechanical gear components within fixed housing 140. The fixed housing 140 holds and positions the yoke assembly 150, which is comprised of the front yoke 152, back yoke 154, a dowel pin 141, a cover plate 146, two sets of scissor jack arms 156. The yoke assembly 150 is designed to facilitate precise movements and adjustments. The front yoke 152 and back yoke 154 are connected by the dowel pins 141, allowing for upward and downward movement. The scissor jack arms 156 provide vertical adjustment capabilities.

A rotational control assembly 180 is comprised of the second cable 53, a universal joint 145, and a spur gear 148. The second cable 53 is responsible for controlling and rotating the spur gear 148. The second cable 53 is connected to the universal joint 145, which is then connected to the spur gear 148. The spur gear 148 is designed to rotate in any direction, as indicated by arrow 94 (shown in FIG. 3A), and engages with a rack gear 134 on the base plate 110. When the spur gear 148 rotates, it uses the rack gear to move the mandibular lower tray 130 left or right. The universal joint 145 ensures smooth and flexible movement in multiple directions, allowing for precise control of the mandibular lower tray 130.

FIGS. 3C-E illustrate various views of a maxillary upper tray 120 of the bite registration device, used with a mechanical method 700 of creating a bite registration, in accordance with an embodiment of the present invention (shown in FIG. 3A). The maxillary upper tray 120 is used to hold impression putty or alginate and capture the mandibular impression. The maxillary upper tray 120 includes cavities 144 for the impression putty, ensuring a secure and accurate bite registration.

FIG. 3C illustrates a perspective view of the maxillary upper tray 120 of the bite registration device, in accordance with an embodiment of the present invention. The figure shows snap connection pins 142 and the upper tray putty cup wall 133.

FIG. 3D illustrates a front view of the maxillary upper tray 120 of the bite registration device, in accordance with an embodiment of the present invention. The figure shows the upper tray putty cup wall 133 and snap connection pins 142.

FIG. 3E illustrates a bottom view of the maxillary upper tray 120 of the bite registration device, in accordance with an embodiment of the present invention. The figure shows snap connection pins 142 that mate with apertures 149 on the fixed housing 140 shown in FIG. 3A.

FIG. 4 illustrates an alternate perspective view of an exploded view of components of the bite registration device 100 using AI, in accordance with an embodiment of the present invention. The bite registration device 100 includes a fixed housing 140 which houses the yoke assembly 150, and transmitter PCB board 162 (“Printed Circuit Board”). Torsion springs 159, positioned between the fixed housing 140 and the base plate 110, are used to bias torque during the movement of the scissor arms and yoke.

When the first cable 50 is rotated, it turns the threaded rod 157 clockwise or counterclockwise, pulling the back yoke 154 closer to or further apart from the front yoke 152 forcing the scissor jack 156 to lower or lift the connected base plate 110. The scissor jack arms 156 travel with the yokes, making them pivot from the mid-point connection in the center of the scissor jack arms 156. This change in angle forces the opposite ends, where dowel pin 141 is located, to move up or down and apart simultaneously. Dowel pin 141 is inserted through a slotted opening 166 in slide rail 164 that is attached to the base plate 110. One of the scissor jack arms 156 is locked, while the of the scissor jack arms 156 is allowed to slide through the slotted opening 166. This mechanism enables the base plate 110, along with the attached mandibular lower tray 130, to move up and down in a level plane.

Transmitter PCB board 162 is a specialized “printed circuit board” designed to facilitate the transmission of signals to the bite registration device 100. The transmitter PCB board 162 works by sending signals through its circuitry to control the functions of the bite registration device. Transmitter PCB board 162 fits into slot 125 a designated space on the fixed housing 140, ensuring secure placement and connection.

The transmitter PCB board 162 is responsible for controlling the movement along the X, Y, and Z axes. It sends signals that transmit the exact real-time location of the lower register. The transmitter PCB board 162 is a type of “printed circuit board” that is often used in CNC (Computer Numerical Control) machines, 3D printers, and other automated systems. The board sends signals to the motors or actuators that control the movement along these axes, ensuring precise positioning and real-time location tracking. The PCB boards are designed to ensure accurate movement of the machine's axes and execute complex machining operations. These boards can control the movements of individual machine axes, such as X, Y, and Z, and ensure precise positioning and smooth motion control.

The mandibular lower tray 130 has snap pins 142 and a locking alignment hole 131 mounted to its underside. The mandibular lower tray 130 connects to the base plate 110 using the snap pins 142, which clip into slots 127 in the base plate 110. The locking alignment hole 131 is used to hold the device in both a closed, compressed position and a zero back/forward position. When the base plate 110 is manually compressed, the locking alignment hole 131 aligns with the connection adaptor 160. At this point, the locking pin 157 can be pushed through both the drive port 147 and the locking alignment hole 131 to attach to the front yoke 152, securing it in a collapsed configuration and in the most backward position. The handle threads 158 on the handle of the locking pin 157 prevent any movement until it is removed. The locking pin 157 is designed to ensure a secure fit, preventing any unintended movement during operation. The drive port 147 and the locking alignment hole 131 are precisely aligned to facilitate easy insertion of the locking pin 157, while the handle threads 158 provide additional stability and security.

FIG. 5A illustrates a perspective view of a mandibular lower tray 130 of the bite registration device, in accordance with an embodiment of the present invention. The mandibular lower tray 130 includes several key components: a tongue guard 138, which helps to protect the tongue during the impression process and multiple cavities 144 for impression putty along its surface and on the lower tray putty cup wall 132.

FIG. 5B illustrates a front view of a lower tray of the bite registration device, in accordance with an embodiment of the present invention. The mandibular lower tray 130 includes several key components: a locking alignment hole 131, used to keep the device pulled together for insertion; a series of square snap connection pins 142, which ensures a secure fit.

FIG. 5C illustrates a bottom view of the mandibular lower tray 130 of the bite registration device, in accordance with an embodiment of the present invention. The lower tray includes a transmitter receiver tape or reflector 143, which is used to measure the amount of movement. The snap connection pins 142 are designed to securely hold the lower tray in place during the bite registration process. The transmitter receiver tape or reflector 143 is strategically positioned to accurately capture and measure the movement of the lower tray, ensuring precise and reliable bite registration. The snap connection pins 142 also provide stability and alignment, preventing any unwanted shifts or movements during the procedure.

FIG. 6 illustrates a schematic diagram of the Wi-Fi and Bluetooth connectivity of the device 100, in accordance with an embodiment of the present invention. The bite registration device 100 transmits jaw movement data to a computing device 171, such as a smart watch, smartphone, smart watch, laptop, tablet, or desktop computer, via a dedicated PCB board 162 with embedded Wi-Fi and Bluetooth modules. In the artificial intelligence embodiment of device 100, embedded sensors and a camera capture movement and position data. Transmitted jaw movement data is outputted in both the XYZ metric system and the US customary system. The PCB board 162 seamlessly communicates with applications on computing device 171. These wireless communication abilities provide operators with bite registration and position data in real time, enabling them to guide the patient during bite registration and scanning. In one embodiment, data is outputted as a timeline 174 on the display screen 172 of a computing device, showing the amount of movement in both the XYZ metric system and the US customary system.

FIG. 7 illustrates a perspective view of the device controller 600 of the bite registration device, in accordance with an embodiment of the present invention. The device controller 600 is designed for easy mobilization and includes several key features. It has a controller housing 620, a control screen 601 to manipulate the movement controls, a cable ribbon 605, and a disconnect system that includes a drive cable connector 602, an SD card slot 603, and a slide plate 604. The control screen 601 communicates with the drive motors via the cable ribbon 605. In another embodiment, a mouse option may be included, allowing an operator to control the movement controls from a short distance away from the control box. This design enhances the flexibility and usability of the device controller 600, making it easier to operate and transport.

The first cable 50, responsible for forward, backward, up, and down movements of the mandibular lower tray 130, is connected to stepper motors 57. Two stepper motors are mounted on a slide plate 604. The bite registration device 100 includes a stepper motor control board that allows for WIFI, Bluetooth, Ethernet, USB, and/or USB-C connectivity. All stepper drives (motors) may be controlled with a standard stepper control board (PCB). The stepper control board transmits a digital reading to a display touch screen 601. Software installed in the stepper control board may allow for the steppers to be “jogged” into the desired travel position to move bite registration 100. This program enables precise control and adjustment of the device's movements and may allow for the bite registration device 100 to return to a specific location so it can be scanned for reproduction use.

In Step 722 of the mechanically-operated bite registration method 700, as viewed in FIG. 8A, the operator places the device back on its holder and uses the “Recall” function to return it to the patient's proper excursion point. This function returns the device to its previously saved position on all three axes simultaneously. Connected cloud storage or a local memory storage device, such as an SD card or flash drive is used to store location information for future use. Wi-Fi/Bluetooth for app or tablet-controlled function can also be supplied on the controller, along with a Universal Serial Bus (USB) connection for outside communication. In some embodiments, a battery can be adapted to allow for remote use of the device controller 600. The device controller 600 may be designed for easy mobilization with features like the upper handle and cable disconnect. The drive cable connector 604 may be connected to a fixed base connector.

FIG. 8A illustrates an example of a flowchart of the mechanically-operated bite registration method 700 for the device, in accordance with an embodiment of the present invention. In step 702, operator select one of the six tray sizes provided with the device, based on the patient's oral cavity dimensions. Here, “operator” refers to a dentist, orthodontist, dental assistant, orthodontic assistant, and the like. In step 704, operator attaches the selected tray to the device. In step 706, operator places the device into the calibration clamp and applies dental putty. In step 708, operator connects the control cables and zeroes the digital reader. Two drive cables, similar in design to tachometer square cables, are engineered to prevent compression during rotation, pushing, or pulling. Recommended connection types include snap or splined magnetic connections. Treated surfaces are acceptable to enhance durability and performance. In step 710, operator inserts the device into the patient's mouth, ensuring it is properly positioned over the teeth and gums. In step 712, operator instructs the patient to bite firmly until the dental putty sets, following the manufacturer's instructions. In step 714, operator uses the computing device interface to navigate the patient's mandibular dental arch to the correct position. Here, the computer/tablet control system features a “JOG” function, allowing movement only while the operator holds down a control button and no continuous motion is permitted. Controls on the computing device interface use a “press-and-hold” mechanism. Once the operator presses the desired direction (e.g., left, right, up, or down), the device will move accordingly until the operator releases the button. To engage the motors, the operator must maintain button pressure. Each axis features its own “zero” calibration button. The device supports both linear and rotary motion, enabling movement in twelve directions. Stepper motor synchronization ensures smooth combination movements. For instance, to move the device to the left, both rack-and-pinion mechanisms extend the arms in unison while the front connection extends at a coordinated rate, creating a seamless movement. All other combined directional movements function similarly, simplifying operation and enhancing precision. In step 716, operator saves the excursion data by pressing the “Save” button. This enables operators to save the bite registration and position data across all axes. In step 718, operator presses the “Close” button to return the device to its starting position. In step 720, operator removes the device from the patient's mouth. In Step 722, operator places the device back on its holder and uses the “Recall” function to return it to the patient's proper excursion point. That is, returns the device to its previously saved position on all three axes simultaneously. In step 724, operator follows the instructions of the dental scanner, or “intraoral scanner,” manufacturer to capture the device recorded image of the patient's excursion. In step 726, operator sends the scanned images to the dental lab using the dental scanner portal. Here, “dental scanner portal,” or “intraoral scanner portal,” refers to software or applications commonly provided by manufacturers of dental scanners. In step 728, operator removes the dental putty. In last step 730, operator presses “Reset” on the device and sanitizes device according to the provided guidelines.

FIG. 8B illustrates an example of a flowchart of the artificial intelligence-operated bite registration method 800 of the device, in accordance with an embodiment of the present invention. The artificial intelligence-operated bite registration method 800 employs and integrates sensors to capture comprehensive 3D imaging data of a patient's mouth without the need for manual “JOG” controls or manual button-holding as described in the mechanically-operated bite registration method 700 of FIG. 8A. By following simple instructions from the operator, the patient assists in accurately aligning the upper and lower jaw for the creation of precise dental prosthetics. Onboard artificial intelligence algorithms process sensor data and camera footage to ensure optimal alignment. In step 802, operator selects one of the six tray sizes provided with the device based on the patient's oral cavity dimensions. In Step 804, operator disconnects the mechanical cords from the device. In Step 806, operator attaches the manual lock and key, ensuring the device is in the zero position. In Step 808, operator mixes and applies dental putty or alginate to both the upper and lower trays. In Step 810, operator inserts the device into the patient's mouth. In Step 812, operator instructs the patient to bite down firmly until the dental putty or alginate sets. In Step 814, operator removes the locking key and guides the patient through full jaw movements, including opening wide, moving forward and backward, and side-to-side movements. Embedded sensors and cameras track jaw positions and movements in real time, gathering preliminary positioning data. Sensor feedback automatically fine-tunes the device's internal positioning. In this step, operator may provide patient with simple instructions such as slight jaw movements to optimize data collection. Through the doctor's instructions, accurate alignment of the upper and lower jaw can be made. In Step 816, device automatically transmits the jaw movement data to the computer/tablet via a dedicated PCB board featuring both Wi-Fi and Bluetooth connectivity. Additionally, connectivity can be done physically between device and computing device such as by USB, USB-C, or Ethernet connections. The artificial intelligence embodiment of the device seamlessly communicates with computing devices, including desktop computers, laptops, tablets, smartphone, and/or smartwatch application(s). Such wireless communication abilities between device and computing devices provide operators with bite registration and position data in real time, enabling the operator to further guide the patient during scanning. In Step 818, operator assists the patient's jaw back to the zero position using the lock and key mechanism. In Step 820, operator locks the device and remove it from the patient's mouth. In Step 822, operator follows the dental scanner manufacturer's instructions to capture the recorded image of the patient's excursion point. Here, “dental scanner” refers to any commonly used intraoral scanners to create a virtual image of the patient's mouth. In Step 824, operator submits the scanned images to the dental lab using the dental scanner portal. Here, “dental scanner portal,” or “intraoral scanner portal,” refers to software or applications commonly provided by manufacturers of dental scanners. Collected data may be stored in secure local or cloud storage. Collected data including 3D images and measurements may be used to design a custom dental prosthetic for the patient. In Step 826, operator removes the dental putty or alginate. In last Step 828, operator presses “Reset” on the computer/tablet interface and sanitizes the device according to the provided guidelines.

FIG. 8C illustrates an example of a flowchart of the device operation method 900 for both the mechanically-operated and artificial intelligence-operated bite registration embodiments. The mechanically-operated embodiment locks-in the patient's jaw position through physical components, while the artificial intelligence-enabled version adds sensors and software for real-time data collection and analysis. Both designs aim to improve fit, comfort, and long-term success of dental restorations even in challenging edentulous scenarios. Steps 902-922 are shared between both mechanically-operated and artificial intelligence-operated bite registration embodiments. In step 902, operator selects one of the six tray devices, based on the patient's sizes provided with the oral cavity dimensions. In step 904, operator attaches the selected tray to the device. In step 906, operator places the device into the holding clamp and applies dental putty. In step 908, operator connects the control cables or locking pin and zeroes the digital reader. In step 910, operator inserts the device into the patient's mouth, ensuring it is properly positioned over the teeth and gums. In step 912, operator instructs the patient to bite firmly until the dental putty or alginate sets. In step 922, operator determines whether the device is mechanically-operated or artificial intelligence-operated.

If the device is determined to be mechanically-operated in step 922, the operator will follow steps of the mechanically-operated bite registration method 700 as seen in FIG. 8A. Following step 922 where mechanical device is determined, operator in step 714 will use the computer/tablet interface to navigate the patient's mandibular dental arch to the correct position. In step 716, operator saves the excursion data by pressing the “Save” button. In step 718, operator presses the “Close” button to return the device to its starting position. In step 720, operator removes the device from the patient's mouth.

If the device is determined to be artificial intelligence-operated in step 922, the operator will follow steps of the artificial intelligence-operated bite registration method 800 as seen in FIG. 8B. Following step 922 where an artificial intelligence device is determined, operator in step 814 removes the locking key and guide the patient through full jaw movements, including opening wide, moving forward and backward, and side-to-side movements. In Step 816, device automatically transmits the jaw movement data to the computer/tablet via a dedicated PCB board featuring both Wi-Fi and Bluetooth connectivity. The artificial intelligence embodiment of the device seamlessly communicates with a computing device, including desktop computers, laptops, tablets, smartphone, and/or smart watch application(s). Such wireless communication abilities provide operators with bite registration and position data in real time, enabling the operator to further guide the patient during scanning. In Step 818, operator assists the patient's jaw back to the zero position using the lock and key mechanism. In Step 820, operator locks the device and remove it from the patient's mouth.

Following step 720 in the case of mechanically-operated devices and step 820 in artificial intelligence-operated devices, operator continues to step 914 shared by both types of devices. In step 914, operator follows the dental scanner manufacturer's instructions to capture the recorded image of the patient's excursion point. In step 916, operator submits the scanned images to the dental lab using the dental scanner portal. In step 918, operator removes the dental putty or alginate. In last step 920, operator presses “Reset” on the computer/tablet interface and sanitizes the device according to the provided guidelines.

As a person skilled in the art will recognize from the previous detailed description and the figures and claims, modifications and changes can be made to the embodiments of the invention without departing from the spirit and scope of this invention as defined in the following claims.

We claim:

1. A bite registration device for creating a dental prosthesis, the bite registration device comprising:
a fixed housing having a bottom surface and a top surface that defines a cavity that houses a yoke assembly and a rotational control assembly;
a base plate connected to the bottom surface of the fixed housing;
a lower impression tray to hold a first amount of removable impression putty, attached to the base plate, wherein the rotational control assembly controls the movement of the lower impression tray;
an upper impression tray to hold a second amount of removable impression putty, attached to the top surface of the fixed housing, wherein the yoke assembly controls the movement of the lower impression tray; and
a bite registration device controller for regulating alignment of the upper impression tray and the lower impression tray.

2. The bite registration device for creating a dental prosthesis of claim 1 wherein the yoke assembly is comprised of a front yoke, a back yoke and a pair of scissor jack arms.

3. The bite registration device for creating a dental prosthesis of claim 1 wherein the rotational control assembly is comprised of a drive cable, a universal joint and a rotating gear, wherein the rotating gear communicates with a rack gear attached to the lower tray to move the lower tray.

4. The bite registration device for creating a dental prosthesis of claim 1 wherein the controller uses at least one transmitter PCB board to digitally record a spatial relationship of a maxillary and a mandibular dental arch to an anatomic horizontal natural head reference point of a user.

5. The bite registration device for creating a dental prosthesis of claim 1 wherein the lower impression tray is comprised of lower tray putty cup wall, which contains the first amount of removable impression putty within the impression lower tray.

6. The bite registration device for creating a dental prosthesis of claim 1 wherein the upper impression tray is comprised of a tongue guard and an upper tray putty cup wall, which contains the second amount of removable impression putty within the impression upper tray.

7. A method for creating a dental prosthesis, the method comprising:
selecting, by an operator, a dental impression tray based on a plurality of oral cavity dimensions of a patient;
attaching, the dental impression tray, to a bite registration device;
placing, the bite registration device, into a calibration clamp;
applying, a dental putty, into the dental impression tray;
connecting, a plurality of control cables, to the bite registration device;
zeroing, a digital reader of the bite registration device;
inserting, the bite registration device, into a mouth of the patient;
positioning, the bite registration device, over a teeth and a gums of the patient;
instructing, the patient, to bite firmly until the dental putty sets;
using, a computing device interface, to navigate a mandibular dental arch of the patient to a to an anatomic horizontal natural head reference point of a user;
generating, from the navigating of the mandibular dental arch of the patient, an excursion data of the patient in real-time;
saving, to a cloud storage system or a local storage system, the excursion data generated from the bite registration device;
returning, via a close button, the bite registration device to a starting position;
removing, from the mouth of the patient, the bite registration device;
placing, on a holder, the bite registration device;
returning, via a recall function, the bite registration device to an excursion point of the patient;
capturing, via a intraoral scanner, an image of an excursion of a patient;
transmitting, the image, to a dental lab using a provided portal of the intraoral scanner;
removing, from the dental impression tray, the dental putty;
pressing, a reset button, on the bite registration device; and
sanitizing the bite registration device.

8. A method for creating a dental prosthesis, the method comprising:
selecting, by an operator, a dental impression tray based on a plurality of oral cavity dimensions of a patient;
disconnecting, from a bite registration device, a plurality of mechanical cords;
attaching, to the bite registration device, a manual lock and a locking key;
zeroing, a digital reader of the bite registration device;
mixing, on a surface, a dental putty or an alginate;
applying, to an upper dental impression tray and a lower dental impression tray, the dental putty or alginate;
inserting, into a mouth of the patient, the bite registration device;
positioning, over a teeth and a gums of the patient, the bite registration device;
instructing, the patient, to bite firmly until the dental putty or the alginate sets;
removing, from the bite registration device, the locking key;
guiding, the patient, through a plurality of jaw movements;
capturing, at least one of a sensor and a camera, a data of the jaw movements;
transmitting, to a computing device, the jaw movement data in real-time;
processing, by a processor having a plurality of algorithms, an optimal alignment of a jaw of the patient;
returning, via the manual lock and a locking key, a jaw of the patient to the zero position;
locking, via the manual lock and a locking key, the bite registration device;
capturing, via a intraoral scanner, an image of an excursion of a patient;
transmitting, the image, to a dental lab using a provided portal of the intraoral scanner;
removing, from the dental impression tray, the dental putty or the alginate;
pressing, a reset button, on an interface of the computing device; and
sanitizing the bite registration device.

9. The method of claim 8, wherein the plurality of jaw movements include an opening wide movement, a moving forward movement, a moving backward movement, and a side-to-side movement.
